(19) United States
(12) Patent Application Publication
(10) Pub. No.: US 2013/0239027 A1
(43) Pub. Date: Sep. 12, 2013

(54) APPARATUS AND METHOD FOR GENERATING WIKI PREVIEWS

(71) Applicant: APPLE INC., Cupertino, CA (US)

(72) Inventors: Andrew J. Nesbitt, Cuptertino, CA (US); Damon Anderson, San Francisco, CA (US); Dimitri Dupuis-Latour, Paris (FR)

(73) Assignee: APPLE INC., Cupertino, CA (US)

(21) Appl. No.: 13/658,042

(22) Filed: Oct. 23, 2012

Related U.S. Application Data
(60) Provisional application No. 61/609,845, filed on Mar. 12, 2012.

(51) Int. Cl. G06F 3/0484

(52) U.S. Cl. CPC G06F 3/0484
USPC 715/760

(57) ABSTRACT

An apparatus and method are described for generating wiki preview pages. For example, one embodiment of a method comprises the operations of: detecting that a wiki page has been edited by a user; responsively generating an entry in a wiki preview queue, the entry containing a network address identifying the edited wiki page and user session data needed to access the wiki page; identifying the edited wiki page within the wiki preview queue; and using the network address and session data needed to access the edited wiki page; taking a snapshot of the wiki page to generate a thumbnail image and using the snapshot to generate a wiki preview page; and storing the wiki preview page with the thumbnail image on a storage device accessible by end users accessing the wiki page.

### CLAIM TO PRIORITY

This application claims priority to U.S. Provisional Patent Application No. 61/609,845, filed on Mar. 12, 2012, entitled, “Apparatus And Method For Generating Wiki Previews.

### BACKGROUND

1. Field of the Invention

This invention relates generally to the field of data processing systems. More particularly, the invention relates to an improved apparatus and method for generating previews of WiKi pages.

2. Description of Related Art

A “Wiki” is a website whose users can edit its content via a Web browser using a simplified markup language or rich text editor. Wikis are implemented using wiki software and are often created collaboratively by multiple users. Exemplary uses of wikis include community websites, corporate intranets, and knowledge management systems.

### BRIEF DESCRIPTION OF THE DRAWINGS

A better understanding of the present invention can be obtained from the following detailed description in conjunction with the following drawings, in which:

FIG. 1 illustrates one embodiment of an architecture for generating wiki previews.

FIG. 2 illustrates one embodiment of a method for generating wiki previews.

FIG. 3A illustrates an exemplary wiki preview page in accordance with one embodiment of the invention.

FIG. 3B-3T illustrate various graphical user interfaces for accessing and editing wiki pages via a tablet based client device.

FIG. 4A illustrates an application programming interface employed in one embodiment of the invention.

FIG. 4B illustrates exemplary applications interfacing to services and operating systems in accordance with one embodiment of the invention.

FIG. 5 illustrates an architecture of a data processing device on which embodiments of the invention may be implemented.

FIG. 6 illustrates another architecture of a data processing device on which embodiments of the invention may be implemented.

### DETAILED DESCRIPTION OF PREFERRED EMBODIMENTS

Described below are embodiments of an apparatus, method, and machine-readable medium for generating wiki preview pages for display on a client computing device. In one embodiment the client device is an iPad™ or iPhone™ device designed by the assignee of the present patent application. It should be noted, however, that the underlying principles of the invention are not limited to any particular type of client device.

Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are not shown or are shown in a block diagram form to avoid obscuring the underlying principles of the present invention.

### Apparatus and Method for Generating Wiki Preview Pages

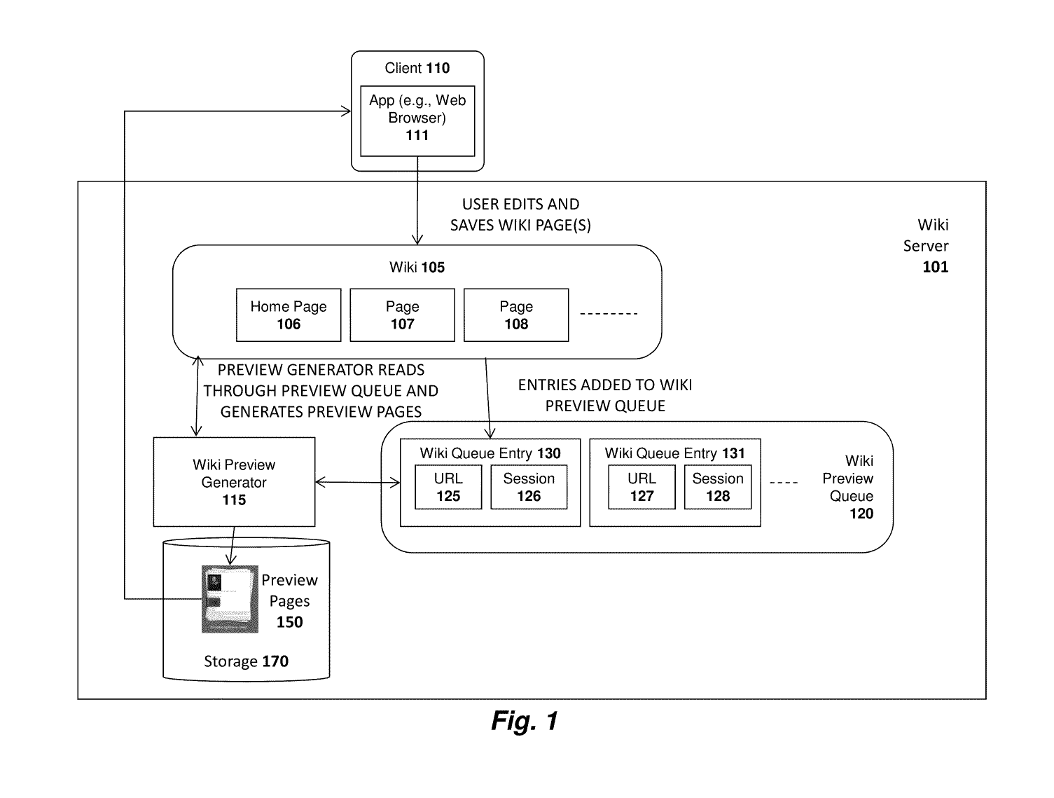

The embodiments of the invention described below generate wiki preview pages for client devices such as the iPad® or iPhone®. As illustrated in FIG. 1, in one embodiment of the invention, the wiki pages 105 are managed on a wiki server 101. Each set of wiki pages 105 may include a home page 106 (i.e., the main page identified by the URL for the wiki) and a set of additional wiki pages 107-108, all of which may be edited by authorized users.

In operation, a user logs in to the wiki server 101 to edit the wiki pages 106-108 via an app such as a web browser 111 executed on a client device 110. After editing a wiki page (or multiple pages), the user saves the changes to the wiki pages (e.g., selecting a graphical “save” button from within the web browser). In response, in one embodiment, the wiki server saves the changes to the wiki pages and generates an entry for the wiki within a wiki preview queue 120. In the example shown in FIG. 1, changes have been made to the pages 106-108 of wiki 105 and, as a result, a new wiki queue entry 130 is generated within the wiki preview queue 120 for that wiki. Similarly, other wiki queue entries 131 may be added to the wiki preview queue 120 for other wiki pages (not shown).

In one embodiment, each wiki queue entry 130 includes a uniform resource locator (URL) 125 (or other network address) identifying the wiki 105 on the network and a session component 126 containing authentication data required to access the wiki. For example, some wikis require user authentication for access such as a user name and password. In such a case, the session data 126 contains the authentication/user data needed to access the wiki associated with the wiki queue entry 130.

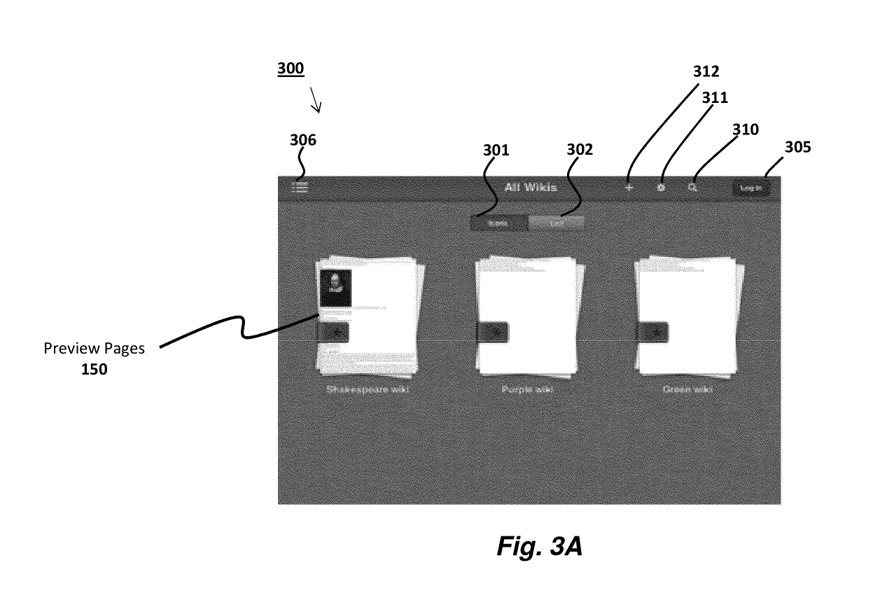

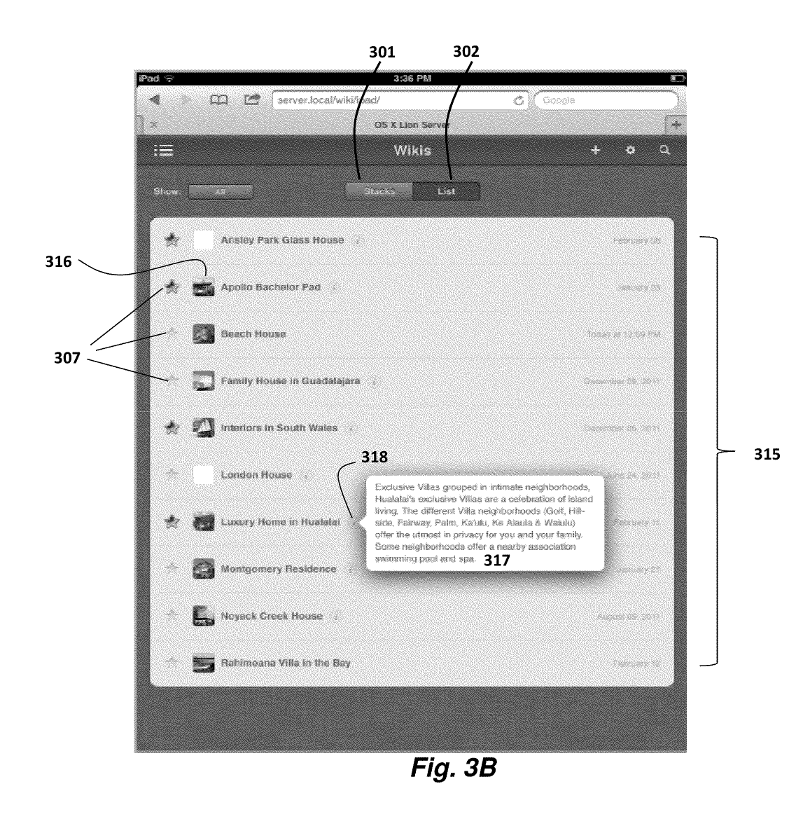

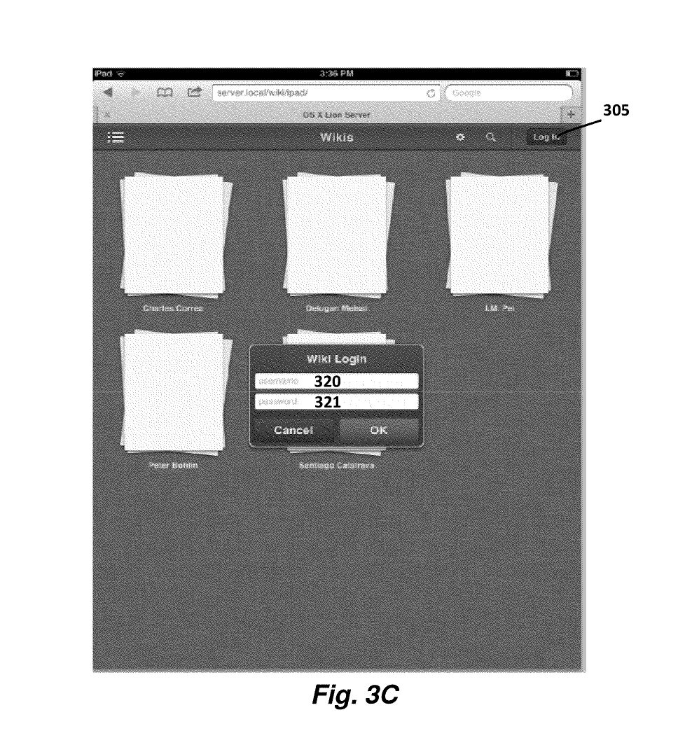

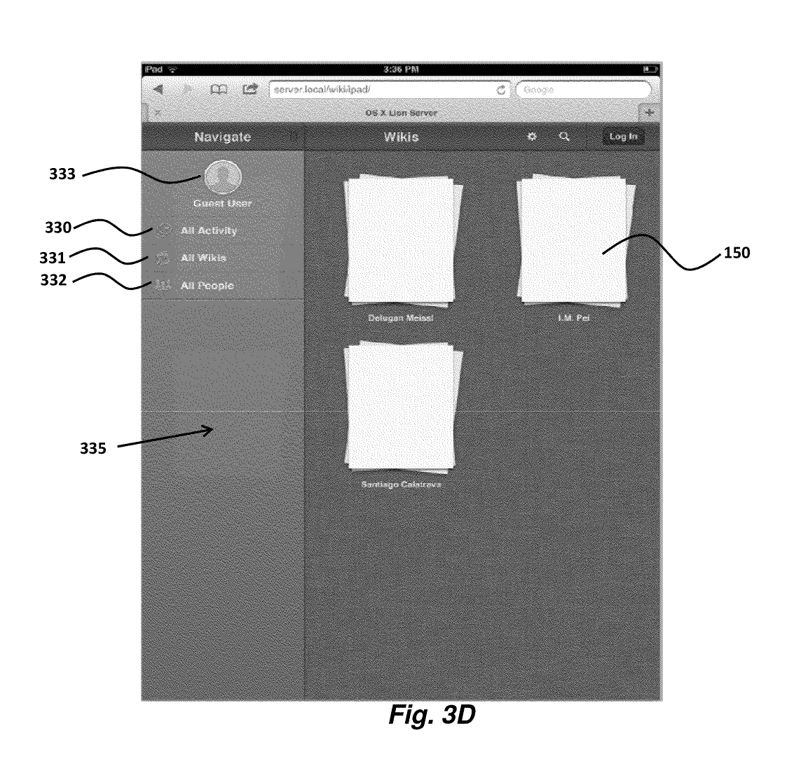

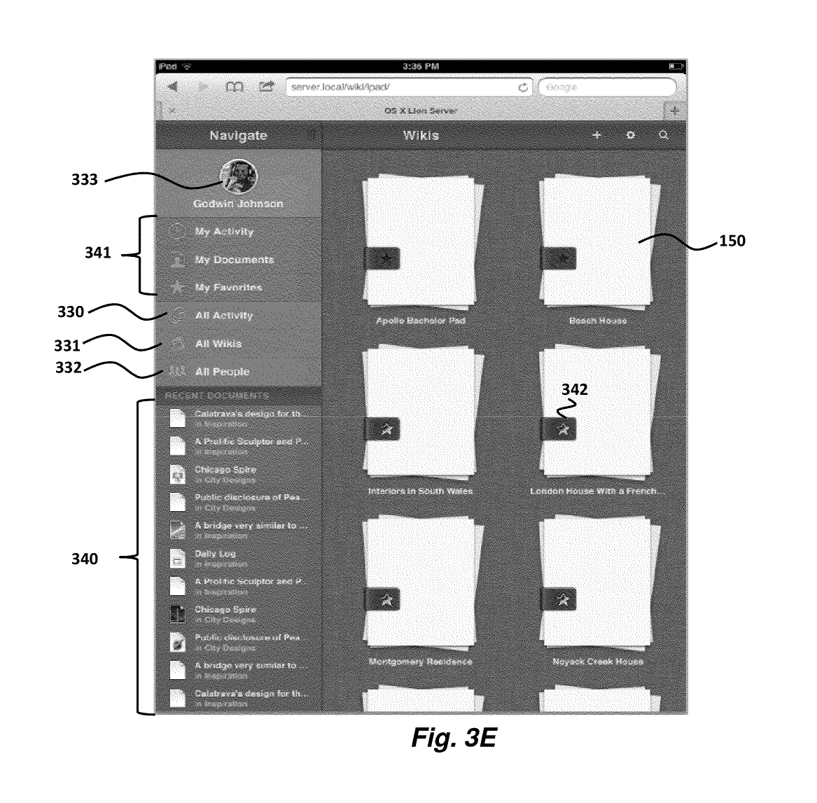

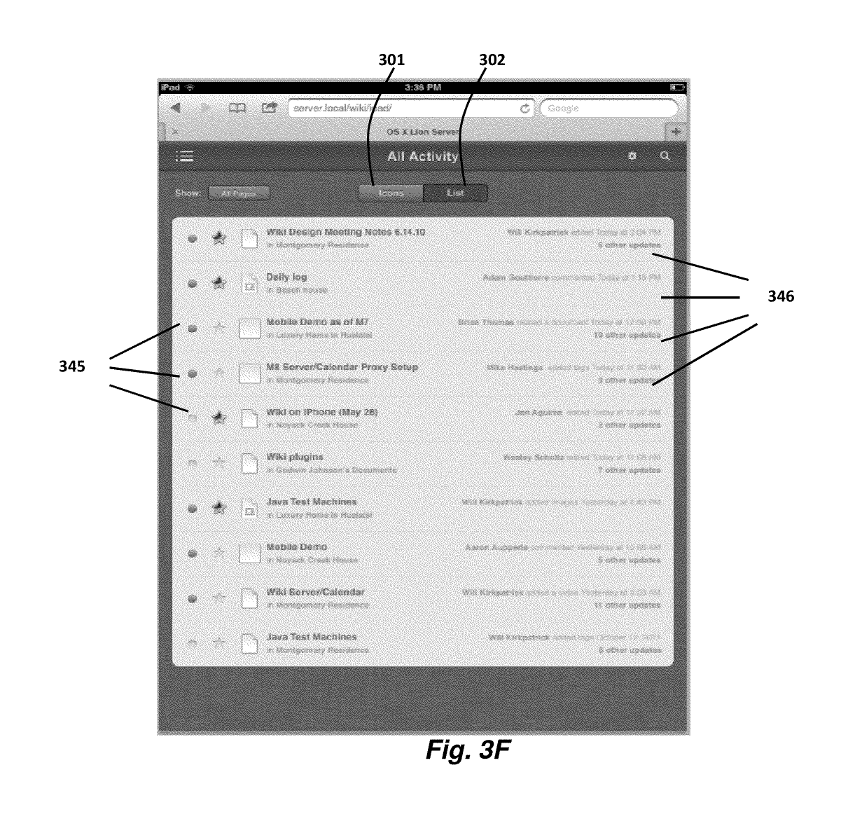

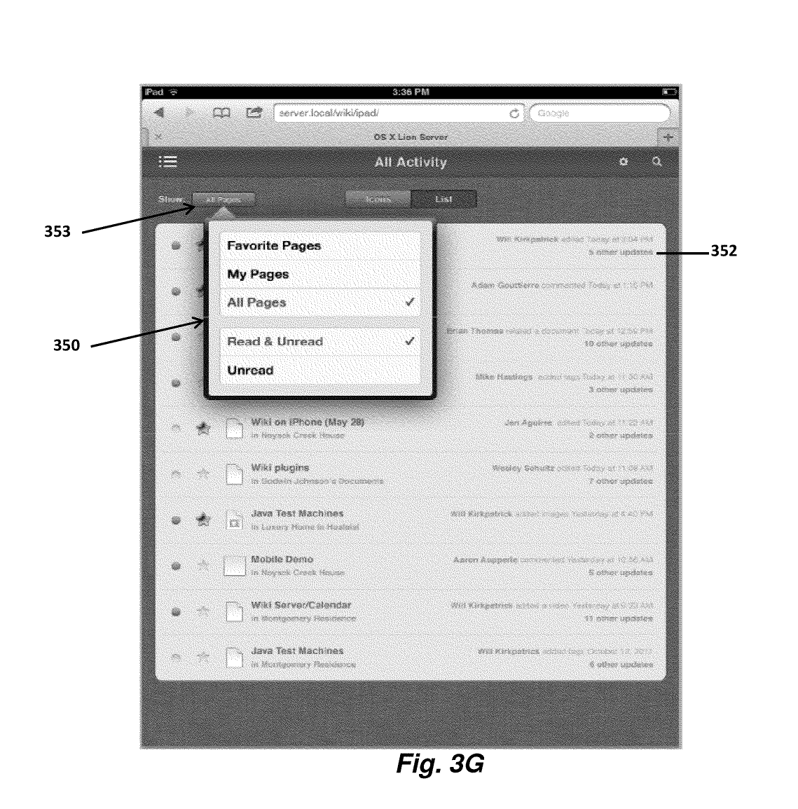

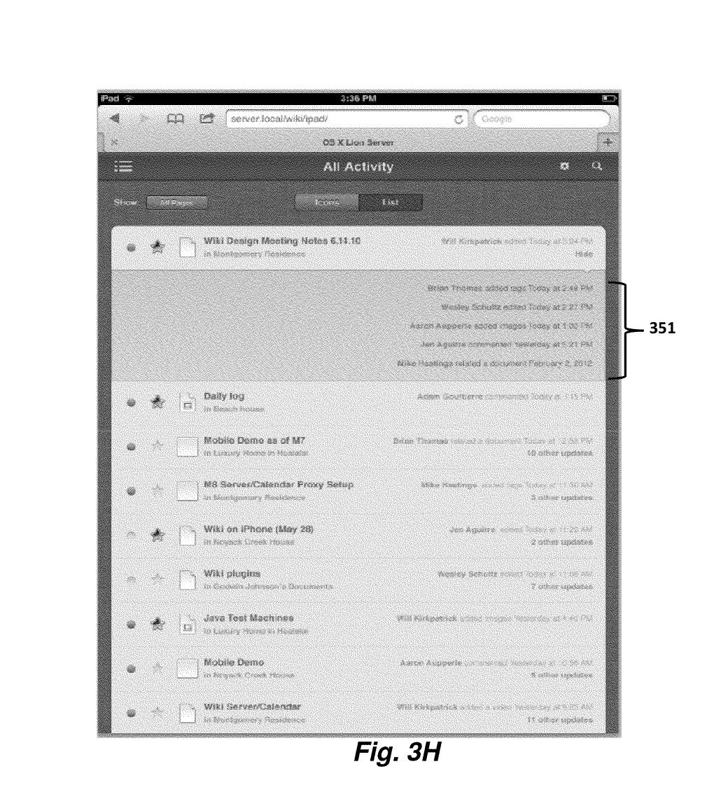

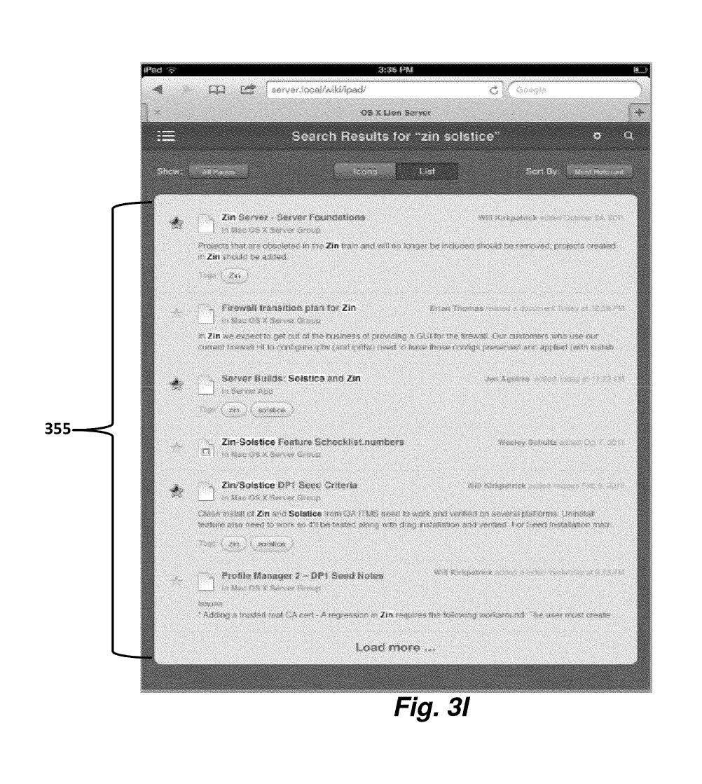

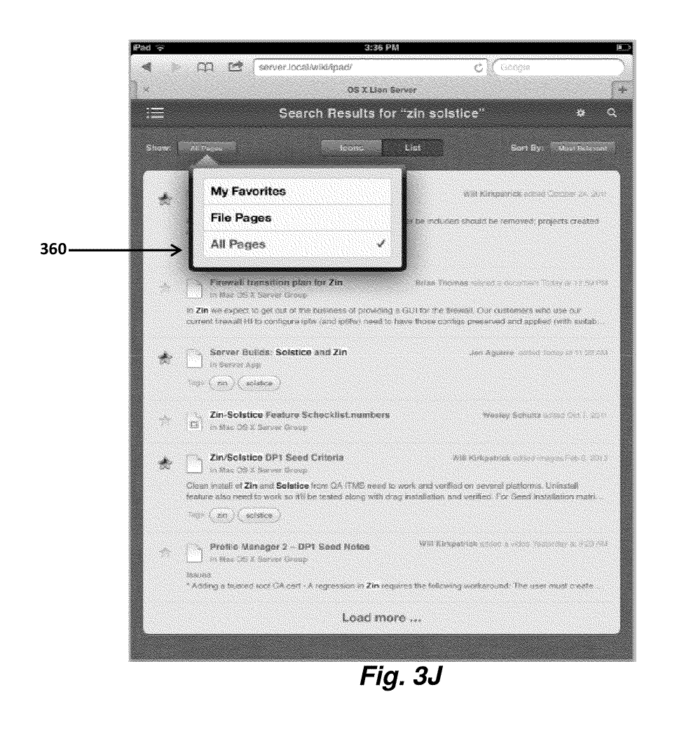

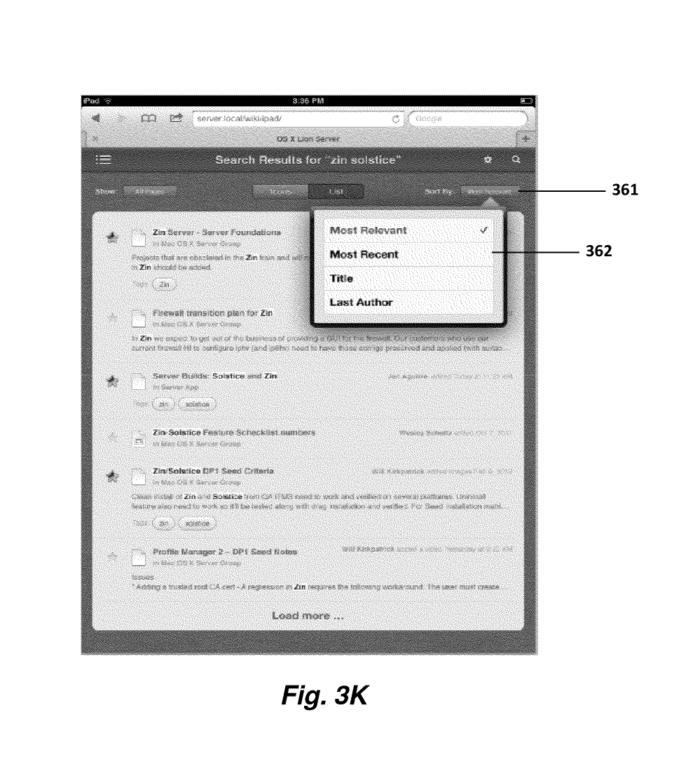

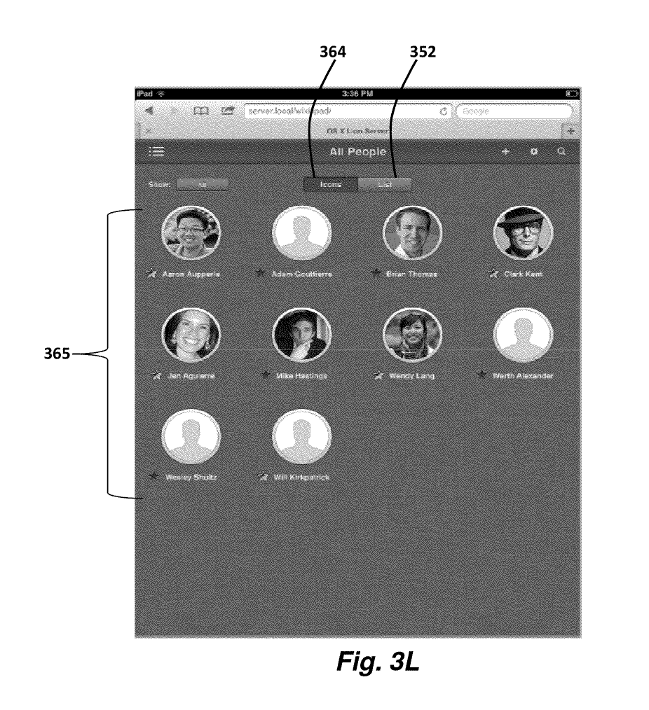

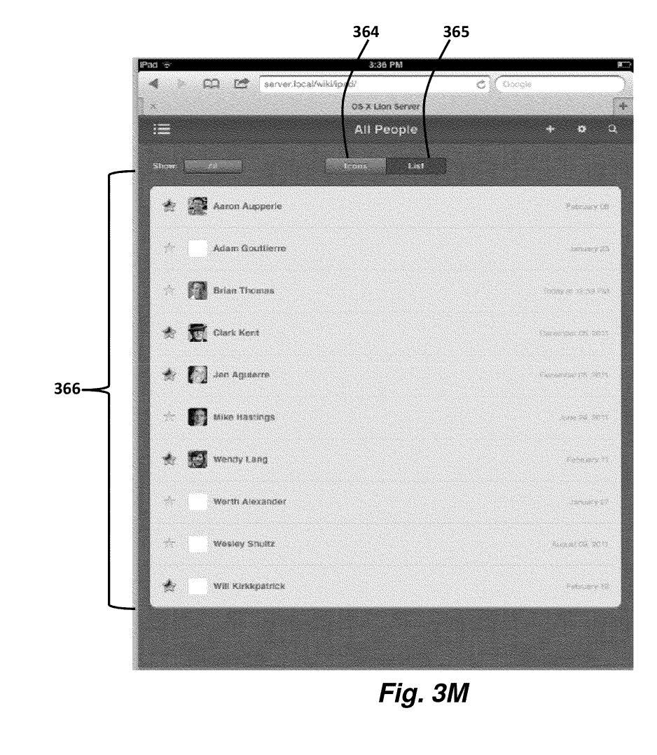

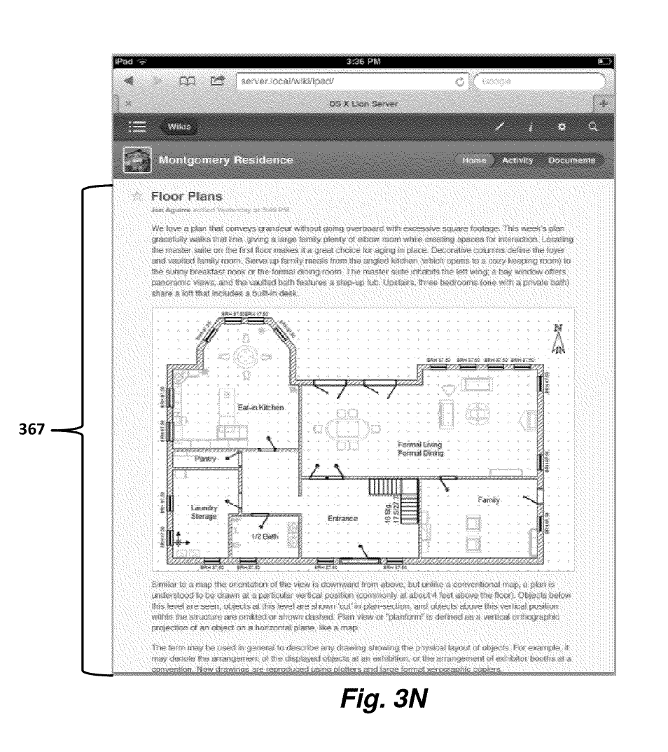

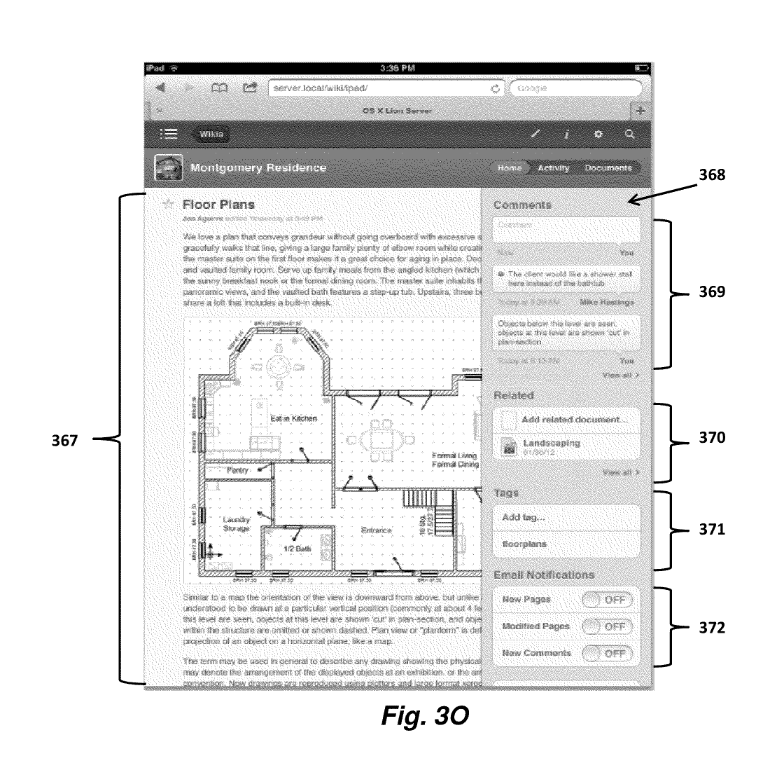

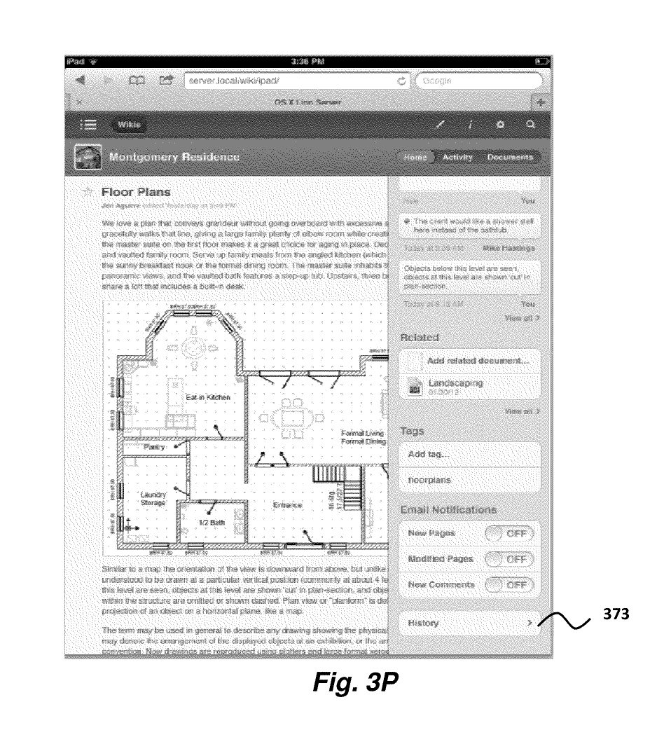

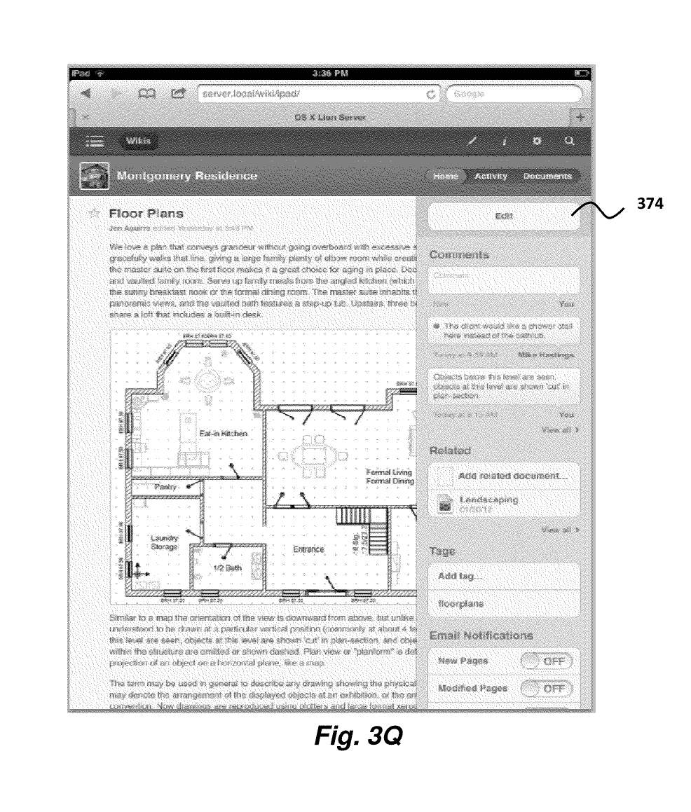

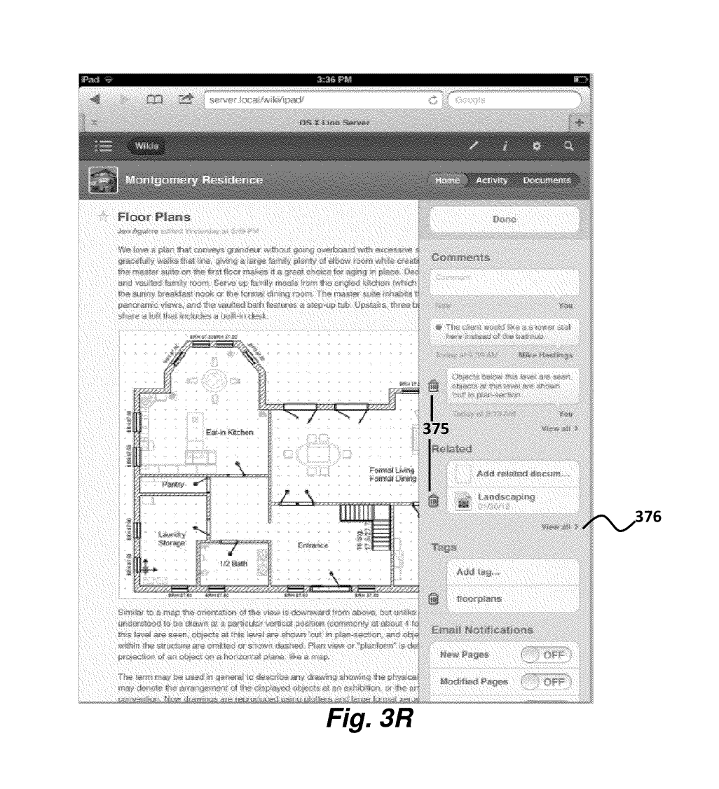

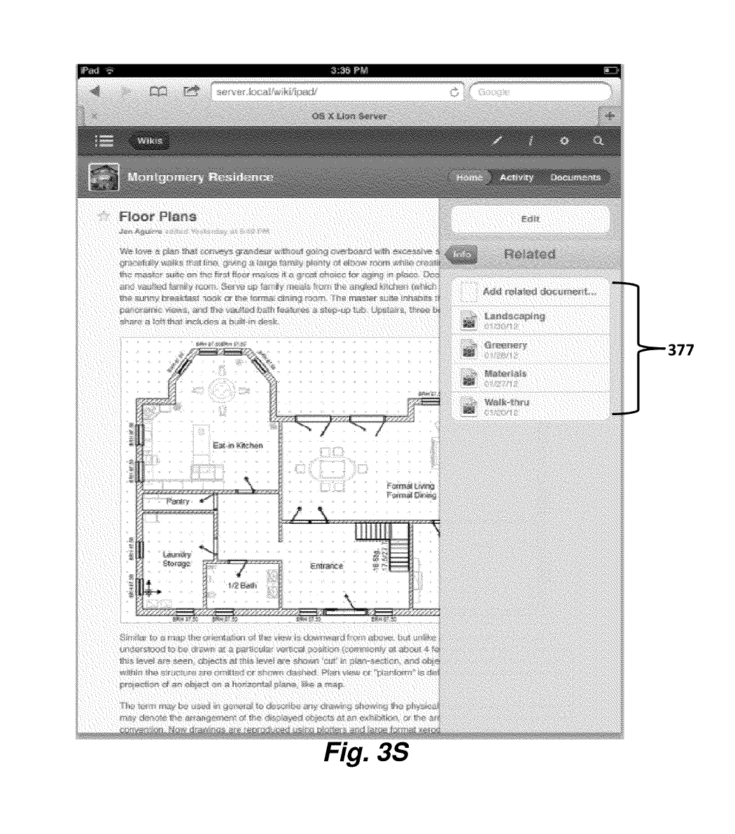

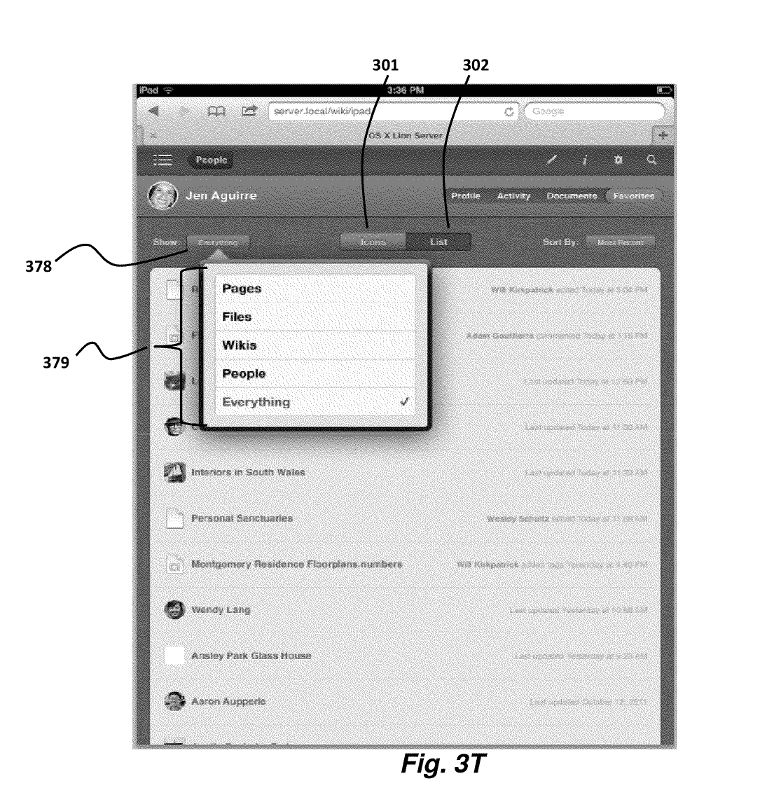

In one embodiment of the invention, a wiki preview generator 115 periodically reads through the wiki preview queue entries 130-131 and generates wiki preview pages 150 for each identified wiki. In one embodiment, the wiki preview generator identifies the location of the wiki 105 using the URL 125 and uses the session data 126 to access the wiki on behalf of the user who made the changes to the wiki. Once accessed, the wiki preview generator 115 takes a snapshot of the home wiki page 106 and generates a thumbnail image of the home wiki page 106 for the wiki preview 150. In one embodiment, the “snapshot” is in the format of a portable network graphic (PNG) object. However, various other formats may be used while still complying with the underlying principles of the invention (e.g., JPEG, GIF or BMP images). The wiki preview pages are then provided to requesting client devices 110 to generate thumbnail wiki previews 150 such as illustrated in FIG. 3A (e.g., having the graphical appearance of a stack of wiki pages with the home page on top). In one embodiment, the preview pages 150 may be cached/stored on a storage device 170 such as a memory or a mass storage device (e.g., so that, once generated, they may be reused in response to subsequent client requests).

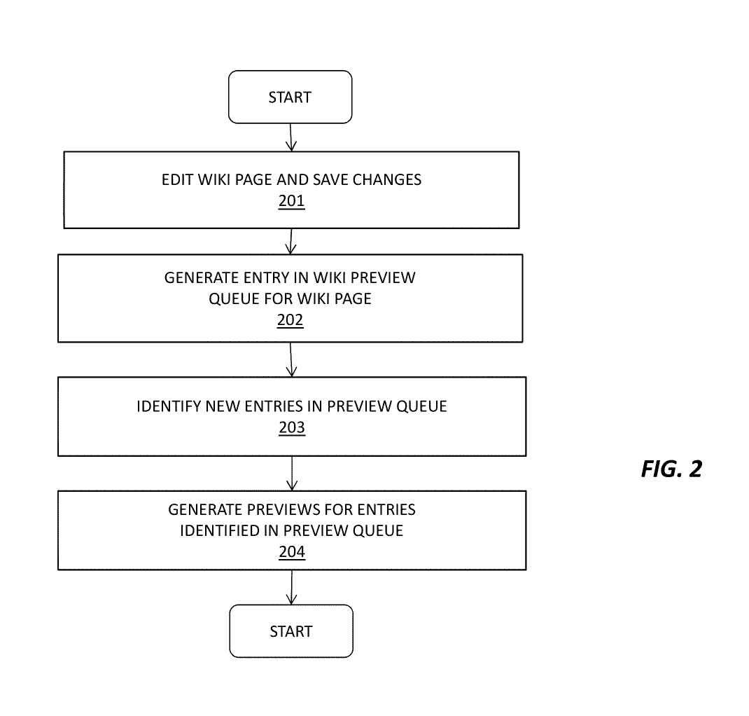

A method in accordance with one embodiment of the invention is illustrated in FIG. 2. At 201, a user logs in, edits a wiki page and saves the changes. At 202, a new entry is generated in the wiki preview queue for the wiki page (e.g., containing a URL and session data for the wiki). At 203, new entries in the preview queue are identified and, at 204, preview pages for those wikis are automatically generated. In one embodiment, the method is performed by program code executed on a processor such as a general purpose processor of the wiki server 101.

FIGS. 3B through 3T illustrate exemplary graphical user interfaces (GUIs) employed on a client device for navigating through wiki pages and editing wiki pages on a tablet-based computer such as an iPad in accordance with one embodiment of the invention.

FIG. 3A illustrates a plurality of wiki preview pages 150 displayed as a stack of papers within a navigation region of the GUI 300. In one embodiment, the wiki preview pages are graphically displayed on top of each stack. Selection buttons 301 and 302 are provided to allow the user to select between viewing the wiki preview pages 150 as a set of icons/stacks 301 and viewing the wiki preview pages 150 as a list 302 (e.g., as shown in FIG. 3B). A navigation button 306 allows the user to select navigation and filtering options for displaying the wiki preview pages 150 (e.g., as described in detail below). A “+” graphical element 312 is provided to allow the user to add wiki pages to those being navigated; a configuration graphical element 311 is provided to allow the end user to select additional configuration options; a search element 310 is provided to allow the user to execute a search for new wiki pages (e.g., by entering keywords or other text); and a login element 305 is provided to allow the user to provide authentication data such as a user name and password to authenticate with the wiki server 101. Once authenticated, the wiki server 101 provides the user with access to a specified set of wiki pages (and wiki preview pages). The GUI features and options associated with these graphical elements are described below.

As illustrated in FIG. 3B, the wiki preview pages may be displayed in a graphical listing 315 in response to the user selecting the “list” graphical element 302 from the GUI. Each wiki entry in the list may include a graphical thumbnail 316 displaying the wiki preview page or other graphical content associated with the wiki page. In addition, graphical stars 307 are used to highlight those wiki pages of a particular category (e.g., those wikis included in the user's “favorites,” those which have been recently modified, previously viewed, etc). In one embodiment, the graphical stars 307 are used to flag a wiki/person or wiki page or uploaded file as a “favorite.” In the specific example shown in FIG. 3B, the graphical star for wiki preview entry 316 has been highlighted.

In one embodiment, an information graphic 318 is associated with each entry in the wiki list. Selecting the information graphic 318 on the touchscreen display causes an information box 317 to appear containing additional information related to the wiki, as shown.

As illustrated in FIG. 3C, in response to the user selecting the login element 305, an authentication window may be displayed with a first field 320 for entering a user name and a second field 321 for entering a password. As mentioned, the wiki server 101 may provide the user with access to a specified set of wiki pages upon entering a valid user ID and password.

As illustrated in FIG. 3D, a navigation region 335 may be displayed in response to the user selecting the navigation element 306 from the GUI. In one embodiment, the navigation region 335 provides a graphical representation of the current user 333 (a guest user in the example) and a plurality of options 330-332 for displaying/filtering wiki preview pages 150 within the navigation window. In the specific example shown in FIG. 3D, the options include “all activity” 330 for displaying all recent activity associated with wiki pages; “all wikis” 331 for displaying all wiki preview pages which the user is authorized to access; and “all people” 332 for displaying a listing of wiki users associated with the current user on the wiki server 101 (e.g., the user's “friends”). In response to the selection of each of these options, the wiki preview pages displayed in the navigation region are updated accordingly.

FIG. 3E illustrates one embodiment of a GUI in which a known user has logged in to the wiki server 101. A set of additional navigation elements 341 are displayed under the user graphic 333 including a “my activity” to display recent activity of the user within the wiki navigation region; “my documents” to display all of the user's wiki documents (and potentially other documents); and “my favorites” to display a set of wikis designated as the user's favorites. In addition, a listing of documents recently accessed by the user is displayed within a “recent documents” region 340. In addition, FIG. 3E illustrates a graphical star element 342 to highlight those wiki pages of a particular category (e.g., those wikis included in the user's “favorites,” those which have been recently modified, etc).

FIG. 3F illustrates a GUI for selecting a group of wiki pages (and potentially other documents) on which the user may perform a group operation. Selection buttons 345 are provided to select a group of documents. A wiki document is selected by highlighting the selection button 345 for that wiki document. Once selected, a particular operation may be performed with respect to the selected group of wiki documents (e.g., a deletion operation, a move operation, etc). In addition, in the GUI shown in FIG. 3F, additional information 346 is provided for each entry in the wiki document list. By way of example, the information may include the number of updates since the last time the user viewed the document, the identity of the last user to modify the document, and the date/time of the most recent modifications to the document. Various other information may be displayed for each wiki document in the list while still complying with the underlying principles of the invention.

FIG. 3G illustrates additional wiki document/preview filtering options which may be provided in one embodiment of the invention. In particular, a filtering element 353 is provided (labeled “show” in FIG. 3G) to allow the user to display particular categories of wiki preview pages/documents. In response to the show element 353 being selected, a selection menu 350 allows the user to display all wiki pages, only favorite wiki pages, or only the user's pages (i.e., via the “my pages” option). In addition, the user may select between “read and unread” or only “unread” wiki documents or preview pages. Selecting one of the options from the selection menu 350 causes a check mark to be displayed next to that option (indicating that the option has been selected). In response to the selection, only wiki preview pages/documents associated with the selected category will be displayed within the graphical listing of wiki preview pages/documents (e.g., only unread documents in response to selection of the “unread” option).

Among the information provided for each wiki entry in the list is a link 352 to show the various updates which have been made to the associated wiki document. For example, in response to the user selecting the link 352, a listing of updates 351 are displayed beneath the wiki entry as shown in FIG. 3H. In one embodiment, the listing of updates includes the user who performed the update, the type of update (e.g., added tags, edited, added images, commented, etc) and the date/time when the update was performed.

As mentioned above, a user may perform a search by selecting the search element 310 and then entering specific keywords, other text, or other search variables (e.g., document modification date, date range, user name, etc). In response, a listing of the search results may be displayed such as shown in FIG. 3I. As with other listings, the listing may display the wiki preview page and other information related to the wiki document (e.g., last modified, identity of the user who performed the modifications, etc).

In addition, as shown in FIG. 3J, the same types of filtering options for further filtering the search results may be provided. For example, the selection menu 360 shown in FIG. 3J allows the user to select “all pages,” “file pages” or “my favorites.” In one embodiment, the wiki allows a user to create wiki pages that are editable and upload attachment files to those pages. The user may also upload files directly to a wiki, and when view these “top level” files—which are referred to herein as “file pages.”

FIG. 3K illustrates a “sort by” element 361 allowing the user to sort the list of wiki entries based on variables such as “most relevant” (placing those wiki entries which are most relevant to the user's search at the top of the list); “most recent” (placing the most recently created or edited documents at the top of the list): “title” (listing alphabetically by title); and “last author” (listing alphabetically by author). The “sort by” functionality may be provided to any listing of wiki entries including those which have been generated as the result of a search and those that have been generated based on filtering via the navigation region 335.

In one embodiment, in response to the “all people” 332 option being selected in FIG. 3D, a graphical representation of each of the users of the wiki server 101 (or a subset of user's who are “friends” or otherwise associated with the current user) may be displayed. As shown in FIG. 3L, graphical depictions of each of the users (e.g., thumbnail photos) may be displayed within the navigation region 365. In one embodiment, selecting one of the graphical depictions will cause the wiki preview pages associated with that user to appear within the navigation region. FIG. 3M illustrates representations of each of the users displayed in a list format 366 in response to a user selecting the list element 352 in FIGS. 3L-M. The elements in the list may be arranged in a variety of ways depending on the selections made by the end user (see, e.g., selection menu 362 in FIG. 3K).

FIG. 3N illustrates an actual wiki page 367 which has been selected by the end user (e.g., by selecting one of the wiki preview pages as discussed above). As illustrated, the wiki page may contain a variety of information including both text and graphical content.

FIG. 3O illustrates the same wiki page, but the user has now caused a set of selectable options associated with the wiki page to be displayed in an options menu 368. As illustrated, the options may include comments and a region for entering comments 369; a listing of related documents 370 (each of which may be selected); an option to add a tag to the wiki page 371; and different email notification triggers 372. For example, the user may configure email triggers to notify the user any time a new page is created, an existing page is modified, or whenever new comments are posted. While email is used in FIG. 3O, triggers may be established for various other types of electronic messaging including instant messaging, text messaging, and push notification messaging (e.g., as used for the iPhone and other devices designed by the assignee of the present patent application). FIG. 3P illustrates a history option 373 which allows the end user to browse through a history of previously accessed wiki pages.

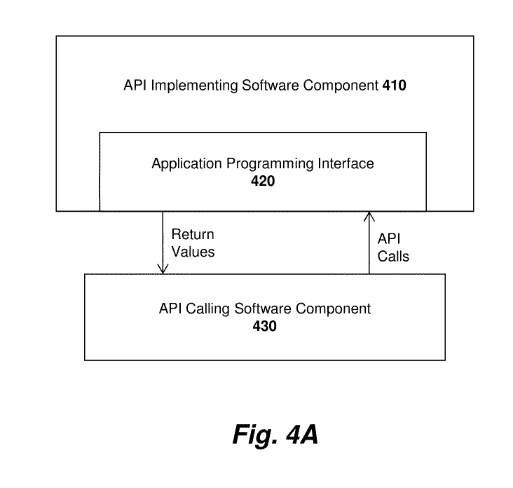

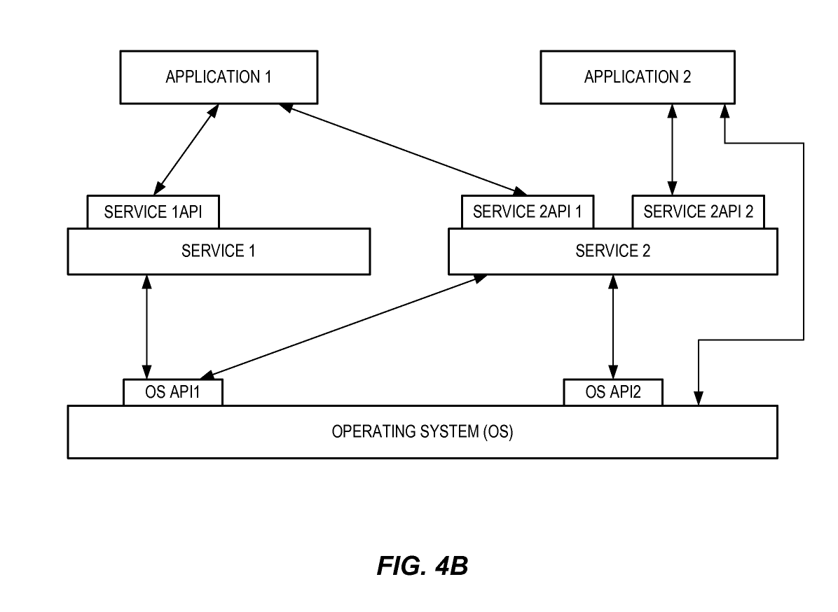

FIG. 3Q illustrates an edit element 374 allowing the user to edit the content associated with the wiki page. For example, as illustrated in FIG. 3R, in one embodiment, selecting the edit element 374 causes deletion graphics 375 to be generated for deleting content previously entered via the options menu including comments, related documents, and tags. In addition, several “view all” options 376 are shown in FIG. 3R allowing the user to view all content in a particular category. One example is provided in FIG. 4S, which shows a listing of all related documents generated in response to user selection of the “view all” option for related documents.

FIG. 3T illustrates a selection menu 379 generated in response to a user selecting a filtering graphical element 378 (labeled “show” in FIG. 3T). In response, only those wiki preview pages associated with the selected category are displayed within the navigation region. The options shown in FIG. 3T includes “Pages,” “Files,” “Wikis,” “People,” and “Everything.” In one embodiment, Pages are wiki pages that are created and edited on the Web. Files are either attachments or files that have been directly uploaded to a wiki. A wiki is a collection of pages and files, and has an optional group calendar and blog. A user may view the activity for a wiki, which is everything that has changed inside that wiki. A wiki may be thought of as a “project” (e.g., my house renovation wiki).

In one embodiment, when an entry is placed in a preview queue when a page has been saved, the preview is almost always generated as the user who saved the page using that users original “session.” This is done so the preview process that comes along later and takes a snapshot of the page as an image has permission to view the resource. In one embodiment, when the server is upgraded from a previous OS which did not have this new feature, all pages are automatically placed in the preview queue, and in this instance a special authentication “session” is used that is reserved for privileged processes that are trusted.

The embodiments of the invention described above provide a useful mechanism for tracking changes to wiki pages and responsively generating new wiki preview pages for display on graphical client devices. While many specific details have been set forth above, it should be noted that the underlying principles of the invention are not limited to these specific details.

### Different API Embodiments

Different embodiments described herein include an application programming interface (API) implemented by a software component (hereinafter “API implementing software component”) that allows a different software component (hereinafter “API calling software component”) to access and use one or more functions, methods, procedures, data structures, and/or other services provided by the API implementing software component. For example, an API allows a developer of an API calling software component (which may be a third party developer) to leverage specified features provided by an API implementing software component. There may be one API calling software component or there may be more than one such software component. An API can be a source code interface that a computer system or program library provides in order to support requests for services from a software application. An API can be specified in terms of a programming language that can be interpretative or compiled when an application is built, rather than an explicit low level description of how data is laid out in memory.

The API defines the language and parameters that API calling software components use when accessing and using specified features of the API implementing software component. For example, an API calling software component accesses the specified features of the API implementing software component through one or more API calls (sometimes referred to as function or method calls) exposed by the API. The API implementing software component may return a value through the API in response to an API call from an API calling software component. While the API defines the syntax and result of an API call (e.g., how to invoke the API call and what the API call does), the API typically does not reveal how the API call accomplishes the function specified by the API call. Various function calls or messages are transferred via the one or more application programming interfaces between the calling software (API calling software component) and an API implementing software component. Transferring the function calls or messages may include issuing, initiating, invoking, calling, receiving, returning, or responding to the function calls or messages. Hence, an API calling software component can transfer a call and an API implementing software component can transfer a call.

By way of example, the API implementing software component 2010 and the API calling software component may be an operating system, a library, a device driver, an API, an application program, or other software module (it should be understood that the API implementing software component and the API calling software component may be the same or different type of software module from each other). The API calling software component may be a local software component (i.e., on the same data processing system as the API implementing software component) or a remote software component (i.e., on a different data processing system as the API implementing software component) that communicates with the API implementing software component through the API over a network. It should be understood that an API implementing software component may also act as an API calling software component (i.e., it may make API calls to an API exposed by a different API implementing software component) and an API calling software component may also act as an API implementing software component by implementing an API that is exposed to a different API calling software component.

The API may allow multiple API calling software components written in different programming languages to communicate with the API implementing software component (thus the API may include features for translating calls and returns between the API implementing software component and the API calling software component); however the API may be implemented in terms of a specific programming language.

FIG. 4A illustrates one embodiment of an API architecture which includes an API implementing software component 410 (e.g., an operating system, a library, a device driver, an API, an application program, or other software module) that implements the API 420. The API 420 specifies one or more functions, methods, classes, objects, protocols, data structures, formats and/or other features of the API implementing software component that may be used by the API calling software component 430. The API 420 can specify at least one calling convention that specifies how a function in the API implementing software component receives parameters from the API calling software component and how the function returns a result to the API calling software component. The API calling software component 430 (e.g., an operating system, a library, a device driver, an API, an application program, or other software module), makes API calls through the API 420 to access and use the features of the API implementing software component 410 that are specified by the API 420. The API implementing software component 410 may return a value through the API 420 to the API calling software component 430 in response to an API call.

It will be appreciated that the API implementing software component 410 may include additional functions, methods, classes, data structures, and/or other features that are not specified through the API 420 and are not available to the API calling software component 430. It should be understood that the API calling software component 430 may be on the same system as the API implementing software component 410 or may be located remotely and accesses the API implementing software component 410 using the API 420 over a network. While FIG. 4A illustrates a single API calling software component 430 interacting with the API 420, it should be understood that other API calling software components, which may be written in different languages (or the same language) than the API calling software component 430, may use the API 420.

The API implementing software component 410, the API 420, and the API calling software component 430 may be stored in a machine-readable medium, which includes any mechanism for storing information in a form readable by a machine (e.g., a computer or other data processing system). For example, a machine-readable medium includes magnetic disks, optical disks, random access memory; read only memory, flash memory devices, etc.

In FIG. 4 (“Software Stack”), an exemplary embodiment, applications can make calls to Services 1 or 2 using several Service APIs and to Operating System (OS) using several OS APIs. Services 1 and 2 can make calls to OS using several OS APIs.

Note that the Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2.

### Exemplary Data Processing Devices

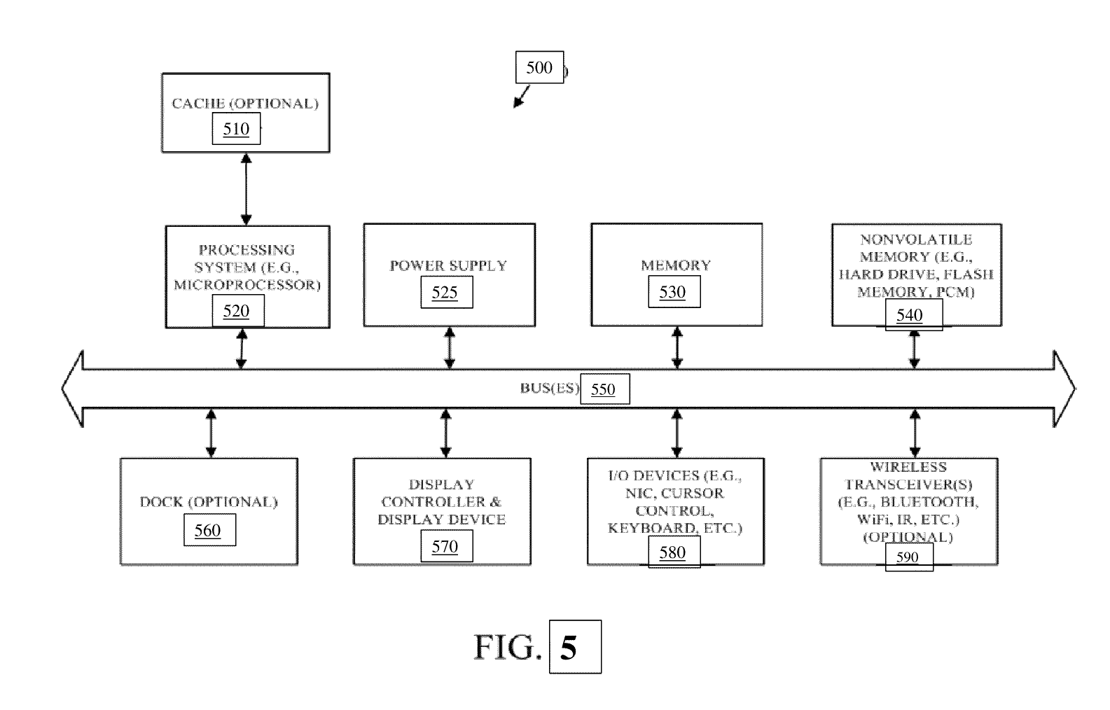

FIG. 5 is a block diagram illustrating an exemplary computer system which may be used in some embodiments of the invention. It should be understood that while FIG. 5 illustrates various components of a computer system, it is not intended to represent any particular architecture or manner of interconnecting the components as such details are not germane to the present invention. It will be appreciated that other computer systems that have fewer components or more components may also be used with the present invention.

As illustrated in FIG. 5, the computer system 500, which is a form of a data processing system, includes the bus(es) 550 which is coupled with the processing system 520, power supply 525, memory 530, and the nonvolatile memory 540 (e.g., a hard drive, flash memory, Phase-Change Memory (PCM), etc.). The bus(es) 550 may be connected to each other through various bridges, controllers, and/or adapters as is well known in the art. The processing system 520 may retrieve instruction(s) from the memory 530 and/or the nonvolatile memory 540, and execute the instructions to perform operations as described above. The bus 550 interconnects the above components together and also interconnects those components to the optional dock 560, the display controller & display device 570, Input/Output devices 580 (e.g., NIC (Network Interface Card), a cursor control (e.g., mouse, touchscreen, touchpad, etc.), a keyboard, etc.), and the optional wireless transceiver(s) 590 (e.g., Bluetooth, WiFi, Infrared, etc.).

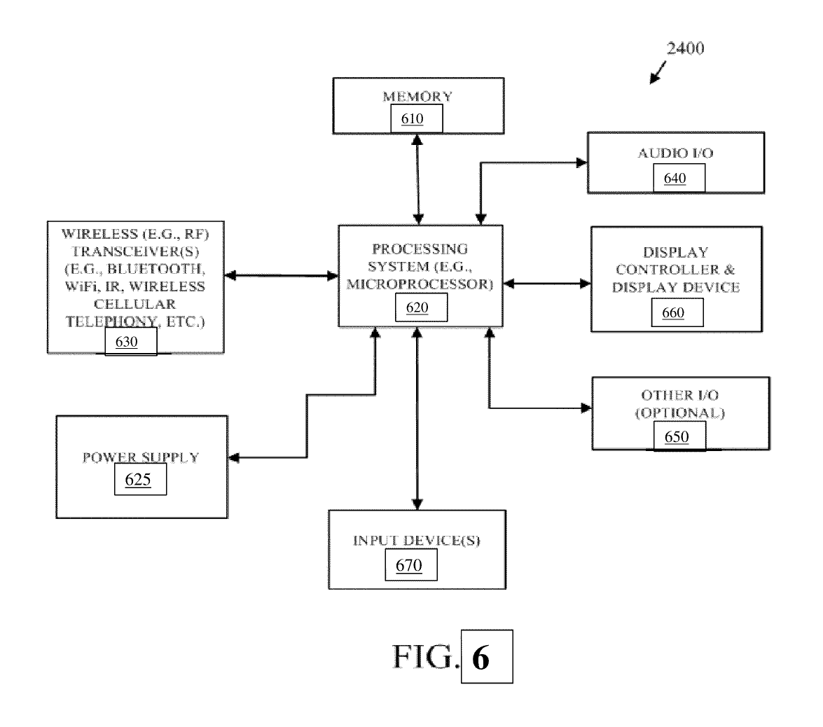

FIG. 6 is a block diagram illustrating an exemplary data processing system which may be used in some embodiments of the invention. For example, the data processing system 600 may be a handheld computer, a personal digital assistant (PDA), a mobile telephone, a portable gaming system, a portable media player, a tablet or a handheld computing device which may include a mobile telephone, a media player, and/or a gaming system. As another example, the data processing system 600 may be a network computer or an embedded processing device within another device.

According to one embodiment of the invention, the exemplary architecture of the data processing system 600 may used for the mobile devices described above. The data processing system 600 includes the processing system 620, which may include one or more microprocessors and/or a system on an integrated circuit. The processing system 620 is coupled with a memory 610, a power supply 625 (which includes one or more batteries) an audio input/output 640, a display controller and display device 660, optional input/output 650, input device(s) 670, and wireless transceiver(s) 630. It will be appreciated that additional components, not shown in FIG. 6, may also be a part of the data processing system 600 in certain embodiments of the invention, and in certain embodiments of the invention fewer components than shown in FIG. 6 may be used. In addition, it will be appreciated that one or more buses, not shown in FIG. 6, may be used to interconnect the various components as is well known in the art.

The memory 610 may store data and/or programs for execution by the data processing system 600. The audio input/output 640 may include a microphone and/or a speaker to, for example, play music and/or provide telephony functionality through the speaker and microphone. The display controller and display device 660 may include a graphical user interface (GUI). The wireless (e.g., RF) transceivers 630 (e.g., a WiFi transceiver, an infrared transceiver, a Bluetooth transceiver, a wireless cellular telephony transceiver, etc.) may be used to communicate with other data processing systems. The one or more input devices 670 allow a user to provide input to the system. These input devices may be a keypad, keyboard, touch panel, multi touch panel, etc. The optional other input/output 650 may be a connector for a dock.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable program code. The machine-readable medium may include, but is not limited to, floppy diskettes, optical disks, CD-ROMs, and magneto-optical disks, ROMs, RAMs, EPROMs, EEPROMs, magnetic or optical cards, or other type of media/machine-readable medium suitable for storing electronic program code.

Throughout the foregoing description, for the purposes of explanation, numerous specific details were set forth in order to provide a thorough understanding of the invention. It will be apparent, however, to one skilled in the art that the invention may be practiced without some of these specific details. For example, it will be readily apparent to those of skill in the art that the functional modules and methods described herein may be implemented as software, hardware or any combination thereof. Moreover, although embodiments of the invention are described herein within the context of a mobile computing environment (i.e., using mobile devices 120-123; 601-603), the underlying principles of the invention are not limited to a mobile computing implementation. Virtually any type of client or peer data processing devices may be used in some embodiments including, for example, desktop or workstation computers. Accordingly, the scope and spirit of the invention should be judged in terms of the claims which follow.

We claim:

1. A computer implemented method for generating wiki preview pages comprising:
detecting that a wiki page has been edited or created by a user;
processing the wiki page to generate a thumbnail image and using the thumbnail image to generate a wiki preview page; and
storing the wiki preview page with the thumbnail image on a storage device accessible by end users accessing the wiki page.

2. The method as in claim 1 further comprising:
detecting that a user is accessing the wiki page via a touchscreen client; and
responsively providing the wiki preview page to the user's touchscreen client.

3. The method as in claim 1 further comprising:
responsively generating an entry in a wiki preview queue, the entry containing a network address identifying the edited or new wiki page and user session data needed to access the wiki page;

4. The method as in claim 3 wherein the network address comprises a uniform resource locator (URL).

5. The method as in claim 3 wherein the session data comprises a user identification code and password needed to access the wiki page.

6. The method as in claim 3 further comprising:
identifying the edited wiki page within the wiki preview queue; and
using the network address and session data needed to access the edited wiki page.

7. The method as in claim 1 wherein processing the wiki page to generate a thumbnail image comprises taking a snapshot of the wiki page; and
using the snapshot to generate the wiki preview page.

8. The method as in claim 7 wherein the snapshot is a portable network graphic (PNG) object.

9. The method as in claim 2 further comprising:
rendering a touchscreen graphical user interface (GUI) for navigating wiki pages, the GUI comprising a browsing window comprising a plurality of wiki preview pages selectable by the user via the touchscreen.

10. The method as in claim 9 wherein the GUI further comprises a first selection button to cause the wiki preview pages to be displayed as a stack of pages with the wiki preview page displayed on top of the stack and a second selection button to cause the wiki preview pages to be displayed in a list.

11. The method as in claim 9 wherein the GUI further comprises a navigation region comprising user-selectable buttons for filtering the wiki preview pages displayed in the browsing window.

12. The method as in claim 11 wherein the user-selectable buttons provide options for filtering based on whether the wiki pages have previously been read by the user, whether the wiki pages are designated by the user as favorites, and based on authorship of the wiki pages.

13. The method as in claim 9 wherein the GUI further comprises a search field to allow the user to perform a search for specific wiki pages.

14. The method as in claim 10 wherein the GUI provides options for ordering the list based on relevance, date, title, and last author.

15. The method as in claim 9 wherein the GUI comprises selectable options for entering comments, displaying related wiki or other documents, and/or adding tags.

16. The method as in claim 9 wherein the GUI comprises selectable options for providing electronic message notifications, the notifications being triggered in response to wiki pages being created, modified, and/or new user comments being associated with a wiki page.

17. A system comprising at least one memory for storing program code and at least one processor for processing the program code to execute the operations of:
detecting that a wiki page has been edited or created by a user;
processing the wiki page to generate a thumbnail image and using the thumbnail image to generate a wiki preview page; and
storing the wiki preview page with the thumbnail image on a storage device accessible by end users accessing the wiki page.

18. The system as in claim 17 comprising additional program code to cause the processor to perform the additional operations of:
detecting that a user is accessing the wiki page via a touchscreen client; and
responsively providing the wiki preview page to the user's touchscreen client.

19. The system as in claim 17 comprising additional program code to cause the processor to perform the additional operations of:
responsively generating an entry in a wiki preview queue, the entry containing a network address identifying the edited or new wiki page and user session data needed to access the wiki page;

20. The system as in claim 19 wherein the network address comprises a uniform resource locator (URL).

21. The system as in claim 19 wherein the session data comprises a user identification code and password needed to access the wiki page.

22. The system as in claim 19 comprising additional program code to cause the processor to perform the additional operations of:
identifying the edited wiki page within the wiki preview queue; and
using the network address and session data needed to access the edited wiki page.

23. The system as in claim 17 wherein processing the wiki page to generate a thumbnail image comprises taking a snapshot of the wiki page; and
using the snapshot to generate the wiki preview page.

24. The system as in claim 23 wherein the snapshot is a portable network graphic (PNG) object.

25. The system as in claim 18 wherein the touchscreen client includes a memory for storing program code and a processor for processing the program code to execute the operations of:
rendering a touchscreen graphical user interface (GUI) for navigating wiki pages, the GUI comprising a browsing window comprising a plurality of wiki preview pages selectable by the user via the touchscreen.

26. The system as in claim 25 wherein the GUI further comprises a first selection button to cause the wiki preview pages to be displayed as a stack of pages with the wiki preview page displayed on top of the stack and a second selection button to cause the wiki preview pages to be displayed in a list.

27. The system as in claim 25 wherein the GUI further comprises a navigation region comprising user-selectable buttons for filtering the wiki preview pages displayed in the browsing window.

28. The system as in claim 27 wherein the user-selectable buttons provide options for filtering based on whether the wiki pages have previously been read by the user, whether the wiki pages are designated by the user as favorites, and based on authorship of the wiki pages.

29. The system as in claim 25 wherein the GUI further comprises a search field to allow the user to perform a search for specific wiki pages.

30. The system as in claim 26 wherein the GUI provides options for ordering the list based on relevance, date, title, and last author.

31. The system as in claim 25 wherein the GUI comprises selectable options for entering comments, displaying related wiki or other documents, and/or adding tags.

32. The system as in claim 25 wherein the GUI comprises selectable options for providing electronic message notifications, the notifications being triggered in response to wiki pages being created, modified, and/or new user comments being associated with a wiki page.

33. A non-transitory machine-readable medium having program code stored thereon which, when executed by a processor, causes the processor to perform the operations of:
detecting that a wiki page has been edited or created by a user;
processing the wiki page to generate a thumbnail image and using the thumbnail image to generate a wiki preview page; and
storing the wiki preview page with the thumbnail image on a storage device accessible by end users accessing the wiki page.

34. The machine-readable medium as in claim 33 comprising additional program code to cause the processor to perform the additional operations of:
detecting that a user is accessing the wiki page via a touchscreen client; and
responsively providing the wiki preview page to the user's touchscreen client.

35. The machine-readable medium as in claim 33 comprising additional program code to cause the processor to perform the additional operations of:
responsively generating an entry in a wiki preview queue, the entry containing a network address identifying the edited or new wiki page and user session data needed to access the wiki page;

36. The machine-readable medium as in claim 35 wherein the network address comprises a uniform resource locator (URL).

37. The machine-readable medium as in claim 35 wherein the session data comprises a user identification code and password needed to access the wiki page.

38. The machine-readable medium as in claim 35 comprising additional program code to cause the processor to perform the additional operations of:
identifying the edited wiki page within the wiki preview queue; and
using the network address and session data needed to access the edited wiki page.

39. The machine-readable medium as in claim 33 wherein processing the wiki page to generate a thumbnail image comprises taking a snapshot of the wiki page; and
using the snapshot to generate the wiki preview page.

40. The machine-readable medium as in claim 39 wherein the snapshot is a portable network graphic (PNG) object.

41. The machine-readable medium as in claim 34 wherein the touchscreen client includes a memory for storing program code and a processor for processing the program code to execute the operations of:
rendering a touchscreen graphical user interface (GUI) for navigating wiki pages, the GUI comprising a browsing window comprising a plurality of wiki preview pages selectable by the user via the touchscreen.

42. The machine-readable medium as in claim 41 wherein the GUI further comprises a first selection button to cause the wiki preview pages to be displayed as a stack of pages with the wiki preview page displayed on top of the stack and a second selection button to cause the wiki preview pages to be displayed in a list.

43. The machine-readable medium as in claim 41 wherein the GUI further comprises a navigation region comprising user-selectable buttons for filtering the wiki preview pages displayed in the browsing window.

44. The machine-readable medium as in claim 43 wherein the user-selectable buttons provide options for filtering based on whether the wiki pages have previously been read by the user, whether the wiki pages are designated by the user as favorites, and based on authorship of the wiki pages.

45. The machine-readable medium as in claim 41 wherein the GUI further comprises a search field to allow the user to perform a search for specific wiki pages.

46. The machine-readable medium as in claim 42 wherein the GUI provides options for ordering the list based on relevance, date, title, and last author.

47. The machine-readable medium as in claim 41 wherein the GUI comprises selectable options for entering comments, displaying related wiki or other documents, and/or adding tags.

48. The machine-readable medium as in claim 41 wherein the GUI comprises selectable options for providing electronic message notifications, the notifications being triggered in response to wiki pages being created, modified, and/or new user comments being associated with a wiki page.
